(19) United States
(12) Patent Application Publication
(10) Pub. No.: US 2002/0032788 A1
(43) Pub. Date: Mar. 14, 2002

(54) Method and means for transmitting data of different quality of service in internet protocol datagrams

(75) Inventors: Frank Emanuel, Stuttgart (DE); Ulrich Barth, Munchingen (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/882,017

(22) Filed: Jun. 18, 2001

(30) Foreign Application Priority Data
Jun. 26, 2000 (EP) 00 440 190.7

(51) Int. Cl. G06F 15/173

(52) U.S. Cl. 709/230; 709/225

(57) ABSTRACT

The present invention relates to a method of transmitting data (RBP1 to RSP2) of different quality of service in internet protocol datagrams, to a preparation module (SM) therefor, to a receiving module (RM) therefor, and to transmission devices (NB3, RNC2) in each case equipped therewith.

In the method the data are arranged, classified in accordance with their respective quality of service, in queues (QC, QS, QI, QB) assigned to the respective quality of service. The data are packed in data packets (RBP11, CP1, . . . , SP14), the data being segmented in each case as a function of a segmentation rule assigned to the relevant quality of service, and each data packet being assigned an item of data packet control information (PH) with the aid of which data (RPB1, RSP1) contained in the data packets can be reconstructed. As a function of an aggregation rule, containers (C1, C2) of a predetermined payload quantity are formed containing data packets and their respective associated data packet control information (PH), where in at least a part of the data packets, data packets containing data of different quality of service are combined and where the aggregation rule specifies the priority rule in accordance with which data packets of different quality of service are extracted from the queues. A container is made available for transmission in an internet protocol datagram.

### DESCRIPTION

The present invention relates to a method of transmitting data of different quality of service in internet protocol datagrams, a preparation module therefor, a receiving module therefor and transmission devices in each case equipped therewith. The internet protocol is being used increasingly for the transmission of data, with the imposition of different levels of demands on the quality of service (QoS) in each case required for the transmission of the data. For example, speech data on a telephone connection must be transmitted in real time, while for example download data to be loaded onto a terminal via the internet, for example program data files, can be transmitted with delays and with transmission breaks. However, download data often comprise relatively large quantities of data and when the internet protocol is used, which facilitates datagrams of varying size, are transmitted in internet protocol datagrams of corresponding size. On the other hand if speech data are transmitted with the aid of the internet protocol, correspondingly smaller internet protocol datagrams can be formed, although these must be transmitted more frequently than datagrams comprising download data, and possibly also at regular intervals.

If data of differing quality of service, for example the aforementioned speech data and download data, are to be commonly transmitted on a transmission path with a limited transmission bandwidth, a delayed transmission of data of high quality of service (e.g. speech data) takes place because the transmission path is occasionally blocked by internet protocol datagrams containing data of low quality of service, these datagrams also generally being large. With the comparatively dynamic internet protocol, large data quantities can in fact also be transported in a datagram, in contrast for example to ATM technology (ATM=Asynchronous Transfer Mode), in the case of which data must normally be distributed between a plurality of cells due to the fixed, relatively small cell size.

The above described situation generally occurs in a transmission based on the internet protocol, in particular however in access networks, especially mobile telephony access networks, wherein data are to be transmitted between access devices, to which the subscriber terminals are connected, and concentration nodes which serve the access devices. In the case of the Universal Mobile Telecommunications System (UMTS), an access device is referred to as node B and a concentration node to which a plurality of nodes B are connected is referred to as radio network controller (RNC). Between the nodes B and the RNC, transmission takes place of data which is to be sent to a terminal referred to as user equipment and connected to the relevant node B or is to be sent from the terminal to the RNC. Additionally, RNCs transmit such data one between another. The data in question relate to different transport channels, for example a so-called dedicated traffic channel (DTCH) or a random access channel (RACH). The transport channels themselves are assigned to different qualities of service. However data of different quality of service, for example speech- and download data, are also commonly transported on one transport channel.

On account of the above described problems relating to the partially delayed transmission of data of high quality of service, until now transmission based on the internet protocol has not been suitable for access networks, in particular for mobile telephony access networks.

Therefore the objective of the present invention is to provide a transmission of data of different quality of service in internet protocol datagrams optimised in respect of the relevant quality of service of the data to be transmitted.

A method according to the technical theory of claim 1 is provided for the realisation of this objective. Also provided for the realisation of the objective are: a preparation module according to the technical theory of claim 10, a receiving module according to the technical theory of claim 12 and a transmission device according to the technical theory of claim 14 equipped with a preparation module according to the technical theory of claim 10 and/or with a receiving module according to the technical theory of claim 12.

The invention is based on the principle that, for example by means of a preparation module according to the invention, the data to be transmitted are arranged, classified in accordance with their respective quality of service, in queues assigned to the respective quality of service. Furthermore the data are packed in data packets, the data being at least partially segmented in each case as a function of at least one segmentation rule assigned to the relevant quality of service, and each data packet being assigned an item of data packet control information with the aid of which data contained in individual data packets or in data packets of a data packet sequence can be reconstructed. Here larger data units, for example download data, are segmented into smaller data packets, while smaller data units, for example speech data or small data files, are packed unsegmented in data packets. These data packets are extracted from the relevant queues, at least one aggregation rule specifying the priority rule in accordance with which data packets of different quality of service are to be extracted from the relevant queues. For example, data packets comprising speech data are handled with a high priority while data packets comprising download data are extracted with a low priority. A number of extracted data packets are in each case grouped to form a container where, in at least a part of the containers, data packets containing data of different quality of service are combined per container. The containers possess a predetermined payload quantity. A container is preferably firstly filled with data packets comprising data of high quality of service and the remaining container space is filled with data packets comprising data of low quality of service until the payload quantity is reached. Finally a container is in each case made available for transmission in a respective internet protocol datagram.

It is advantageous preferably to segment data of low quality of service, so that data of low quality of service are transmitted together with data of high quality of service, which are to be preferentially transmitted, in each case in relatively small data packets.

In any case it is ensured that on the one hand data of high quality of service are transmitted with a high degree of temporal reliability corresponding to their quality of service, but on the other hand data of low quality of service are also transmitted in the best possible manner. Thus data of low quality of service on the one hand do not block transmission paths and on the other hand do not build up due to data of high quality of service to be preferentially transmitted. The available transmission capacity is in each case optimally utilized as there is a favourable ratio between the respective payload of an internet protocol datagram and its control information governed by the internet protocol. In this way, in particular transmission paths with a relatively small transmission capacity can also be optimally utilized.

In the present context the term “container” is to be understood as an illustrative term for a grouping of data packets which are transmitted in an internet protocol datagram.

Further advantageous developments of the invention are described in the dependent claims.

Following the transmission of the respective internet protocol datagrams to their provided destination, for example to an access device or a concentration node of a (mobile telephony) access network, reconstruction means extract the data packets in each case contained in the containers of the internet protocol datagrams and forward the data contained therein, in accordance with their respective quality of service, to the destination provided for the respective data, where the reconstruction means forward segmented data transmitted in a data packet sequence only when they have reconstructed the data with the aid of the data packet control information in each case assigned to the respective data packets. In this way both segmented and unsegmented data are available again in their original state.

A user datagram protocol layer (UDP) is expediently entered into the internet protocol datagrams on the internet protocol layer. The internet protocol datagrams are then transmitted on the basis of the user datagram protocol. The user datagram protocol offers i.a. a byte-oriented application layer and additionally, with its so-called UDP ports, a further addressing level. The user datagram protocol also facilitates for example an efficient flow monitoring of successfully or unsuccessfully transmitted internet protocol datagrams in the application layer. Basically however it is also possible to use other protocols, for example the transmission control protocol (TCP).

Advantageously, a container in each case forms the payload transported on the user datagram protocol layer.

In an advantageous variant of the invention, a container containing at least one data packet is transmitted when a predetermined time limit is reached, even if the relevant container is not yet filled with data packets up to its predetermined payload quantity. If the relevant data packet contains for example speech data of a telephone connection, a prompt transmission is facilitated in this way.

Combinations of the above described variants and of further implementations described in the dependent claims are readily possible.

other advantageous further developments and embodiments of the invention are described in the dependent claims and the description.

In the following the invention and the advantages thereof will be described in the form of an exemplary embodiment making reference to the drawing wherein:

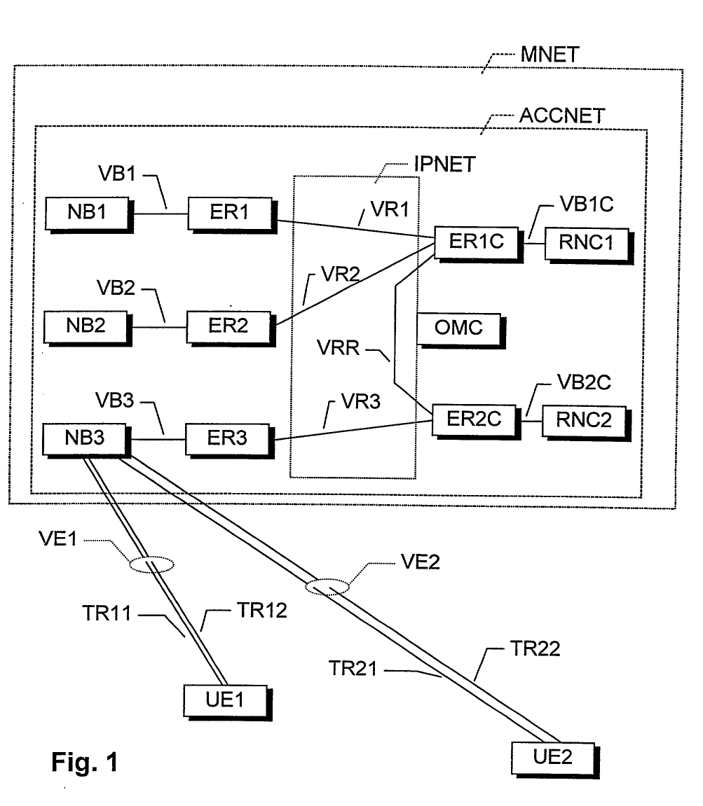

FIG. 1 illustrates an arrangement for the implementation of the method according to the invention with terminals UE1 and UE2, access devices NB1, NB2 and NB3, concentration nodes RNC1 and RNC2 and interface nodes ER1, ER2, ER3, ER1C and ER2C of an access network ACCNET;

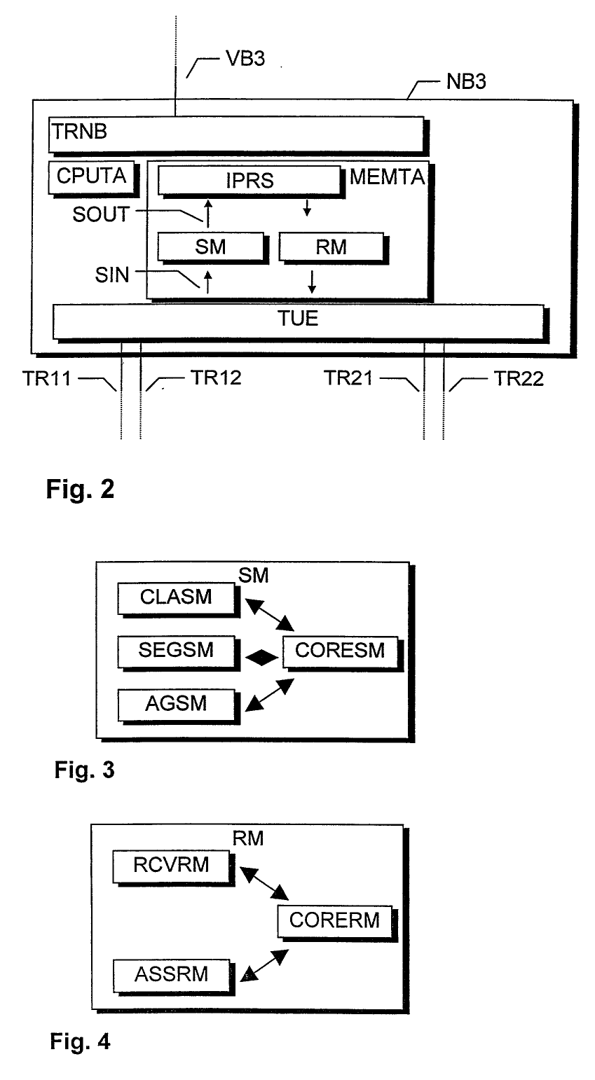

FIG. 2 is a functional diagram of the access device NB1;

FIG. 3 illustrates a schematic construction of a preparation module SM according to the invention;

FIG. 4 illustrates a schematic construction of a receiving module RM according to the invention;

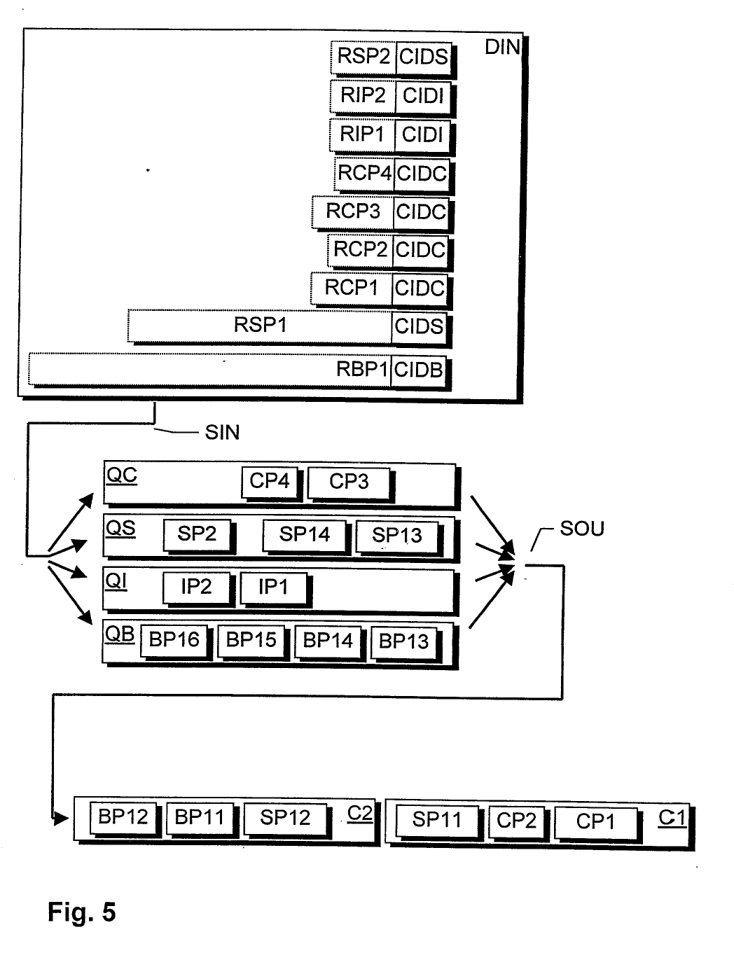

FIG. 5 illustrates an embodiment of the method according to the invention;

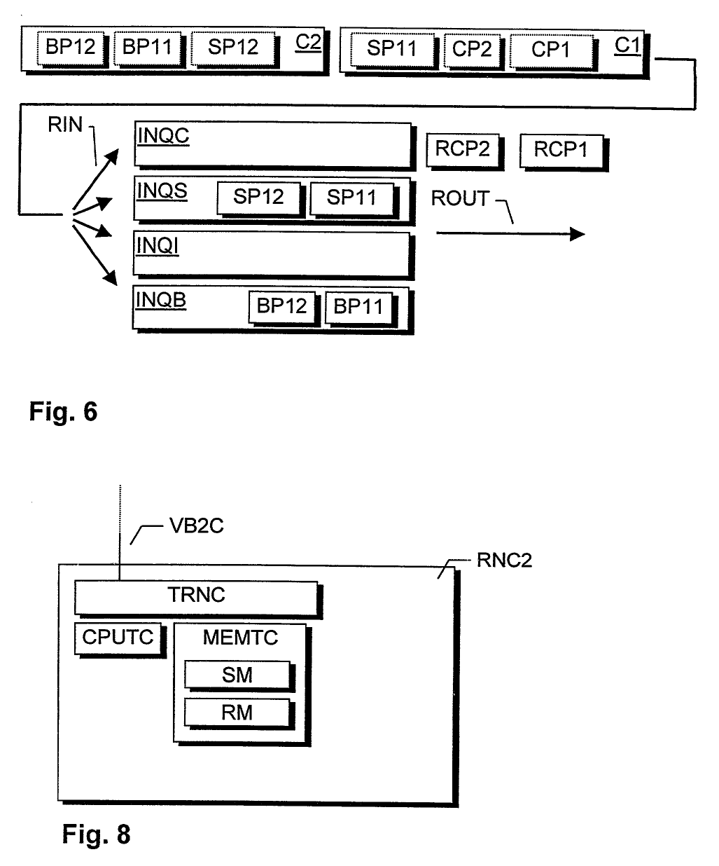

FIG. 6 illustrates a continuation of the method shown in FIG. 5;

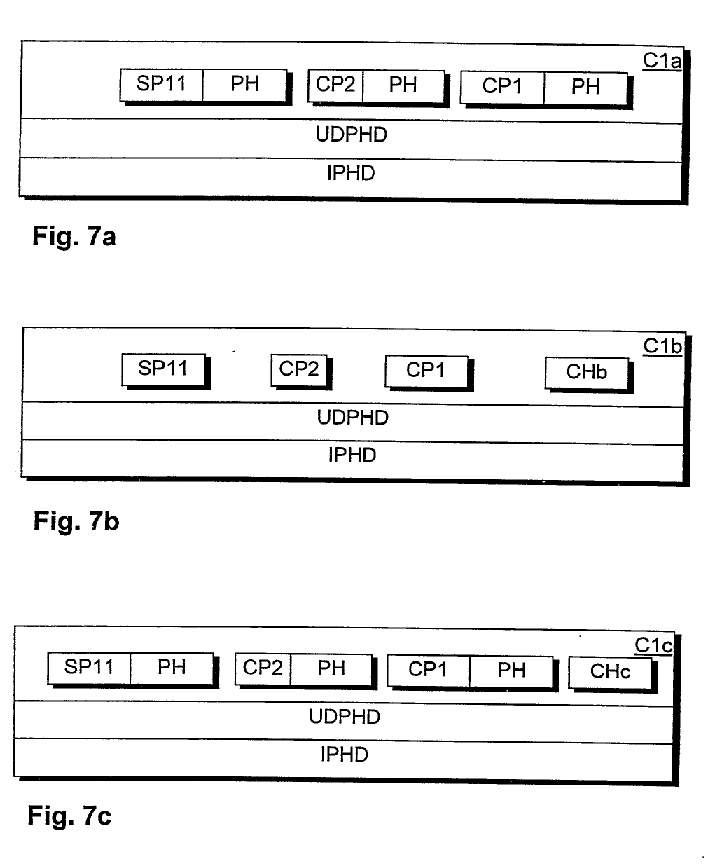

FIG. 7a illustrates an exemplary embodiment of a container C1a;

FIG. 7b illustrates an exemplary embodiment of a container C1b;

FIG. 7c illustrates an exemplary embodiment of a container C1c;

FIG. 8 is a functional diagram of the concentration node RNC2.

FIG. 1 is a highly schematized diagram of an access network ACCNET of a mobile telephony network MNET which supplies terminals UE1 and UE2 and other terminals, not shown here, with mobile telephony services. In the present case the mobile telephone network MNET is a UMTS mobile telephony network (UMTS=Universal Mobile Telecommunications System), for which reason the access network ACCNET is referred to as UTRAN (=UMTS Terrestrial Radio Access Network) in the present case. Of the access network ACCNET, access devices NB1, NB2 and NB3, which in the present case are so-called nodes B, have been shown as transmission devices, as well as concentration nodes RNC1 and RNC2 which in the present case are so-called radio network controllers (RNC). The access devices NB1, NB2 and NB3 are connected to the concentration nodes RNC1 and RNC2 via a network IPNET on which data are transmitted with the aid of the internet protocol. Via a so-called lub-interface, the concentration node RNC1 controls the access devices NB1 and NB2, and the concentration node RNC2 controls the access device NB3 and other access devices not shown. The concentration nodes RNC1 and RNC2 are connected to devices (not shown) of the mobile telephony network MNET, for example to switching centers, routers, other concentration nodes or the like. The concentration nodes RNC1 and RNC2 communicate with one another via a so-called lur-interface. In the exemplary embodiment the lub-interface and the lur-interface conform to the specifications of the 3rd Generation Partnership Project (3GPP).

The interface function to the network IPNET is fulfilled mainly by interface nodes ER1, ER2, ER3 for the access devices NB1, NB2 and NB3 respectively and by interface nodes ER1C and ER2C for the concentration nodes RNC1 and RNC2 respectively. In the present example the interface nodes ER1, ER2, ER3, ER1C and ER2C are so-called edge-routers.

The access device NB3 is connected via the connection VB3 to the interface node ER3. In the same way the access devices NB1 and NB2 are connected via connections VB1 and VB2 respectively to the interface nodes ER1 and ER2 respectively, and the concentration nodes RNC1 and RNC2 are connected via connections VB1C and VB2C respectively to the interface nodes ER1C and ER2C respectively. The connections VB1, VB2, VB3, VB1C and VB2C are connections with a limited transmission capacity. This is relatively small in particular in the case of the connections VB1, VB2 and VB3. The connections VB1, VB2 and VB3 are for example connections of 2,048 megabits per second corresponding to the European E1-specification or of 1,544 megabits per second corresponding to the T1-specification standard in the USA. Higher bit rates can also be provided however.

Connections VR1, VR2 and VR3 exist between the interface nodes ER1 and ER1C, the interface nodes ER2 and ER1C and the interface nodes ER3 and ER2C via the network IPNET. Additionally, the interface nodes ER1C and ER2C are connected to one another via a connection VRR via which the concentration nodes RNC1 and RNC2 can communicate with one another. Depending upon the type of the network IPNET, the connections VR1, VR2, VR3 and VRR are for example logical connections which can lead across different, also changing, connection paths and nodes, for example routers, of the network IPNET or however across fixed, for example switched, connections.

The network IPNET consists for example of a so-called IP backbone network on which for example a virtual private IP network can also be constructed between the interface nodes ER1, ER2, ER3, ER1C and ER2C. The network IPNET can consist of a private IP backbone network which is dedicatedly available for the access network ACCNET, or of a service provider's IP backbone network on which different data traffic to that of the access network ACCNET is also transported. In any case the network IPNET is preferably a network which provides defined qualities of service (QoS) for the transmission and which guarantees protection from unauthorised access to the data transmitted on the network. Therefore in a case of this type so-called tunnel connections, on which communication takes place via tunnel protocols, for example via the so-called IPSecure protocol (IPSec), are established for reasons of security between the interface nodes ER1, ER2, ER3, ER1C and ER2C.

In another advantageous implementation, the network IPNET is a so-called label switching network, for example a multiprotocol label switching (MPLS) network, in which case the connections VR1, VR2, VR3 and VRR lead across so-called label switching tunnels or MPLS tunnels.

The terminals UE1 and UE2, which in the present case are referred to as user equipment, are connected via wireless connections VE1 and VE2 respectively to the access device NB3. Of the connections VE1, VE2, radio transport channels TR11, TR12 and TR21, TR22 respectively have been shown by way of example. The transport channels TR11 and TR21 each comprise one or more dedicated channels (DCH) while the transport channels TR12 and TR22 each comprise one or more random access channels (RACH). Further transport channels and control channels of the connections VE1 VE2, for example forward link access channel (FACH) or broadcast control channel (BCCH), have not been shown for reasons of simplification.

A few essential components of the access device NB3, namely connection means TRNB and TUE, and control means CPUTA and storage means MEMTA, have been shown by way of example. With the connection means TUE the access device NB3 can establish the data- and speech connections VE1 and VE2 to the terminals UE1 and UE2 respectively. With the connection means TUE the access device NB3 can establish the connection VB3. The control means CPUTA comprise a processor or group of processors which can execute program code of program modules, for example a preparation module SM and a receiving module RM, stored in the storage means MEMTA. With the aid of the program modules and under the control of an operating system, the control means CPUTA control the functions of the access device NB3 and thereby influence the functions of the connection means TRNB for example. The connection means TRNB and TUE, the control means CPUTA and the storage means MEMTA are connected to one another by connections not shown in FIG. 2. The access device NB3 can also comprise further assemblies, for example a switching network or an interface to a network management system OMC likewise connected to the network IPNET. In addition to the terminals UE1 and UE2, the access device NB3 also serves other terminals which have not been shown.

In the present case the functions according to the invention of the access device NB3 are performed substantially by the preparation module SM and the receiving module RM in cooperation with a module IPRS for transmitting and receiving internet protocol datagrams. It will be clear that each of the modules RM and SM can also be implemented as hardware, in which case they consist for example of separate plug-in modules or integrated circuits arranged on the connection means TRNB.

In the present case the modules RM and SM each comprise program code which is executed by the control means CPUTA. The modules RM and SM are generated for example in a programming language for example “C”, “C++”, Java or the like and are then translated by a compiler or interpreter into program code which can be executed by the control means CPUTA. The modules RM and SM have been shown only schematically from a functional standpoint and can also have a different individual configuration. Of the preparation module SM, a central control section CORESM has been shown which controls a classification function CLASM serving as classification means, a packing function SEGSM serving as packing means, and an aggregation function AGSM serving as aggregation means. The classification function CLASM, the packing function SEGSM and the aggregation function AGSM could also however have direct interfaces with one another and interact without the control of the control section CORESM. Similarly, in the receiving module RM a receiving function RCVRM serving as receiving means and a reconstruction function ASSRM serving as reconstruction means can interact directly or under the control of a control section CORERM.

In the following, the processing in accordance with the invention by the modules RM and SM of data to be transmitted will be described with reference to FIGS. 5 and 6.

On the transport channels TR11 the access device NB3 receives input data DIN, of which a sequence of data REP1, RSP1, RCP1, RCP2, RCP3, RCP4, R1P1 R1P2 and RSP2 has been shown. These data RBP1 to RSP2 are transported in so-called frame-protocol protocol data units (FP PDUs). Definitions for frame protocols of this kind are given for example in the 3GPP specifications.

The connection means TUE forwards the data RBP1 to RSP2 to the classification function CLASM, as illustrated in the Figure by an arrow SIN. The classification function CLASM arranges the data RBP1 to RSP2 in accordance with their respective quality of service in queues QC, QS, QI and QB assigned to the respective quality of service, conversational, streaming, interactive and background, of the data RBP1 to RSP2. Here the conversational quality of service is assigned for example to call data and the streaming quality of service is assigned for example to music- or video data. The interactive quality of service relates for example to data which is required in internet surfing and is to be interactively exchanged, while the background quality of service relates to data to be transmitted in the uploading or downloading of data files. Other qualities of service are readily possible. It is also possible for example to provide only two qualities of service.

The classification function CLASM determines the relevant quality of service of the data RBP1 to RSP2, in the present case with the aid of channel identifiers CIDC, CIDS, CIDI and CIDB which are attached to the data RBP1 to RSP2 and are assigned to the qualities of service: conversational, streaming, interactive and background. The “interactive” channel identifier CIDI relates for example to a DCH data channel used by the terminal UE1 for internet surfing, while the conversational channel-identifier CIDC relates for example to a so-called coordinated-channel comprising three DCH data channels for call data. In the present case the channel identifiers CIDC, CIDS, CIDI and CIDB also contain an item of information indicating that their respective data are assigned to the terminal UE1 and not to the terminal UE2.

However it is also possible to provide no channel identifiers CIDC, CIDS, CIDI and CIDB. In such a case for example the connection means can enter the data RBP1 to RSP2 directly in the queues QC, QS, QI and QB or in preceding queues.

The packing function SEGSM packs the data RBP1, RSP1, RCP1, RCP2, RCP3, RCP4, RIP1, RIP2 and RSP2 into data packets BP11 to BP16, SP11 to SP14, CP1, CP2, CP3, CP4, IP1, IP2 and SP2 respectively. Here the packing function SEGSM segments the data RBP1 to RSP2 at least partially, in each case as a function of at least one segmentation rule assigned to the relevant quality of service. In the present case the data RCP1, RCP2, RCP3 and RCP4 are call data comprising relatively small quantities of data and therefore are formed unsegmented into data packets CP1, CP2, CP3 and CP4. If, in the case of the conversational quality of service, only small data quantities are expected, a segmentation rule can optionally be omitted for this quality of service. The segmentation rule for the streaming quality of service specifies for example a maximum data packet size, which is undershot by the data RSP2 so that these too are formed unsegmented into a data packet SP2. On the other hand, the relatively extensive data SP1 are distributed between data packets SP11, SP12, SP13 and SP14 The data RIP1, RIP2 undershoot the segment size provided for the interactive quality of service and therefore are formed unsegmented into data packets IP1, IP2. Conversely, the data RBP1 are very extensive and are segmented and formed into relatively small data packets BP11 to BP16.

The packing function SEGSM also assigns each data packet BP11 to BP16, SP11 to SP14, CP1, CP2, CP3, CP4, IP1, IP2 and SP2 items of data packet control information illustrated in FIGS. 7a and 7b as packet header PH and as container header CHb and CHc. The data contained in the data packets can be reconstructed with the aid of the control information. A packet header PH contains for example the relevant channel identifier CIDC, CIDS, CIDI and CIDB or, in a preferred variant of the invention, only a part thereof, for example in each case the lowest value bits. An item of information relating to the size of the relevant data packet is also contained in the control information. For the reconstruction of the segmented data, the control information contains a sequence number of the relevant data packet and a flag indicating whether the relevant data packet is the last data packet of a data packet sequence or whether further data packets follow.

FIGS. 7a to 7c illustrate possible embodiments C1a, C1b, C1c of the container C1. In the containers C1a and C1c each data packet CP1, CP2, SP11 is assigned an item of control information as packet header PH. Conversely, the container C1b has only one container header CHb which for example comprises all the items of control information required for the reconstruction of the data contained in the data packets CP1, CP2, SP11. In addition to the packet headers PH, the container C1c also has a container header CHc containing control information which for example comprises an item of information relating to the number of and/or the total data quantity of the data packets CP1, CP2, SP11 contained in the container C1c. Basically the items of control information can be provided either only in packet headers or also only in container headers or in both types of header depending upon the application.

For greater clarity, in the present case the packing function SEGSM does not become active until the data RBP1 to RSP2 have been entered in the queues QC, QS, QI and QB. However in a preferred variant the packing function SEGSM becomes active first, so that already segmented data or data packets and the associated control information are entered in the queues QC, QS, QI and QB. The classification function CLASM can also be integrated in the packing function SEGSM.

In accordance with the at least one aggregation rule, the aggregation function AGSM extracts data packets of different quality of service from the relevant queues QC, QS, QI and QB and forms containers, as indicated by an arrow SOUT. Containers C1 and C2 containing data packets CP1, CP2, SP11 and SP12, BP11, BP12 respectively have been shown by way of example. The queues QC, QS, QI and QB here are handled in accordance with an assigned priority scheme and in accordance with the at least one aggregation rule. In the present case the queues QC, QS, QI and QB are serviced in descending order of priority, so that for example data packets from the queue QC are always handled preferentially while data packets from the queue QB are extracted only if no data packets are otherwise awaiting transmission. Therefore the data packets CP1 and CP2 from the queue QC are firstly packed in the container C1. The remaining space up to the payload quantity predetermined for the container C1 is used by the data packet SP11. The predetermined payload quantity can in each case be defined by the at least one aggregation rule either as fixed or as variable within predetermined limits. As in the present case the queue QC contains no other data packets at the time at which the container C2 is packed, the aggregation function AGSM packs the data packet SP12 into the container C2 adjoining the container C1. The container C2 is filled with data packets BP11 and BP12 up to its predetermined payload quantity, for example because the space remaining after the data packet SP12 is too small for the data packet S13 or because the at least one aggregation rule specifies that the queues QI and QB are in any case to be serviced at predetermined time intervals. For example it is possible for the priority of a queue to increase if it has not been serviced over a predetermined period of time or if it seems likely to overflow. Suitable priority procedures can however be defined in the aggregation rule.

Then the aggregation function AGSM makes the containers C1 and C2 available for transmission by a transmitting function IPRS serving as transmitting device. The transmitting function IPRS attaches a user datagram protocol header UDPHD and an internet protocol header IPHD to the start of the relevant container and transfers the relevant internet protocol datagrams to the connection means TRNB for transmission to the concentration node RNC2. The transmitting function IPRS can be integrated in the preparation module SM.

In terms of the functions according to the invention, the concentration node RNC2 basically has a similar construction to the access device NB3 and therefore is equipped with control means CPUTC corresponding to the control means CPUTA, storage means CPUTC corresponding to the storage means CPUTA, and connection means TRNC corresponding to the connection means TRNB. Additionally the modules RM and SM, optionally in a form adapted to the concentration node RNC2, are stored in the storage means CPUTC. The respective program code thereof is executed by the control means CPUTC. Further assemblies of the concentration node RNC2 and the internal connections thereof have not been shown for reasons of simplicity.

The concentration node RNC2 receives the internet protocol datagrams with the containers C1 and C2 via the connection means TRNC. The connection means forward the complete internet protocol datagrams, preferably however only the containers C1 and C2 contained therein, to the receiving function RCVRM. In the former case the receiving function RCVRM is designed to receive the complete internet protocol datagrams.

The reconstruction function ASSRM extracts the data packets CP1, CP2, SP11 and SP12, BP11, BP12 from the containers C1 and C2 respectively and arranges these, as indicated by an arrow R1N, in processing queues INQC, INQS, INQI and INQB assigned to the known qualities of service: conversational, streaming, interactive and background. The optionally present items of control information PH and/or CHb, CHc are now extracted from the data packets. The data packets CP1, CP2 contain unsegmented data RCP1, RCP2 which are forwarded by the reconstruction function ASSRM directly to the provided destination. As indicated by an arrow ROUT, they are forwarded by the concentration node RNC2 via the mobile telephony network MNET for example to a terminal (not shown) connected to the access device NB1.

With the aid of the control information PH and/or CHb, CHc, the reconstruction function ASSRM determines that the data packets SP11 and SP12, BP11, BP12 are in each case data packets of a data packet sequence and are still to be completed. Therefore the reconstruction function ASSRM stores the data packets SP11 and SP12 in the queue INQS and the data packets BP11, BP12 in the queue INQB until the last data packets SP14 and BP16 have in each case arrived. Only then does the reconstruction function ASSRM forward the relevant data RSP1 and RBP1 to the provided destination. Destination address information contained in the control information PH and/or CHb, CHc is now evaluated. Depending upon the relevant destination address information, the reconstruction function ASSRM can enter the data for example in storage areas assigned to the destinations. Additionally, from the control information PH and/or CHb, CHc the reconstruction function ASSRM optionally can also regenerate the channel identifiers CIDC, CIDS, CIDI and CIDB or a part thereof and re-assign them to the data.

The receiving function RCVRM and the reconstruction function ASSRM can be combined to form a common function.

The concentration node RNC2 can also transmit data to the access device NB3 in the illustrated manner. The access devices NB1 and NB2 also communicate with the concentration node RNC1 in this way. If the terminal UE1 moves on for example into the radio range of the access device NB2, the data to be transmitted to the terminal UE2 are forwarded by the concentration node RNC2 to the concentration node RNC1 via the connection VRR in the manner according to the invention. The concentration node RNC1 then transmits the relevant data to the access device NB2.

In principle it is also possible to communicate only in one direction in the manner according to the invention, in which case for example the concentration node RNC2 is equipped only with a preparation module SM and the access device NB3 is equipped only with a receiving module RM. In a preferred variant of the invention, which even constitutes an independent invention in its own right, each transport channel type, for example DCH, RACH or FACH, is assigned a UDP port number. This number is entered in the user datagram protocol header UDPHD. Additionally the access device NB3 is assigned an internet protocol address (IP address) which is entered in the internet protocol header IPHD. IP address and UDP port number therefore are advantageously included in the addressing scheme required for the addressing of a particular channel. For example, IP address and UDP port number can be assigned to the channel identifiers CIDC, CIDS, CIDI and CIDB, for example as higher-value bits or additional information, in the mapping of the channel identifiers CIDC, CIDS, CIDI and CIDB onto a radio channel addressing scheme used between access device NB3 and terminal UE1. This results in a large address space, while the addressing information contained in each of the containers is compact. Overall the internet protocol datagrams thus contain relatively little control information. In the present variant of the invention the packing function SEGSM can be equipped with means for extracting the IP address and UDP port number from the relevant channel identifiers CIDC, CIDS, CIDI and CIDB. The receiving function RCVRM and/or reconstruction function ASSRM comprise corresponding means for in each case supplementing the channel identifiers CIDC, CIDS, CIDI and CIDB with IP address and UDP port number.

Fundamentally, data of the transport channels TR11, TR12 and TR21, TR22 can be commonly transported in a container in any desired manner. However if a UDP port number is in each case assigned to a transport channel type, for example on the one hand data of the DCH transport channels TR11 and TR21 and on the other hand data of the RACH transport channels TR12 and TR22 are in each case grouped in containers.

It will be clear that the present invention can be used not only in access networks, in particular not only in mobile telephony access networks, but fundamentally for data traffic based on the internet protocol. It is even possible, as illustrated on the basis of the network IPNET, on the one hand to make available different qualities of service on the internet protocol network layer and on the other hand to obtain a further scaling of the qualities of service on the internet protocol application layer by means of the method according to the invention.

1. A method of transmitting data (RBP1 to RSP2) of different quality of service in internet-protocol-datagrams, characterised in that
the data (RBP1 to RSP2) are arranged, classified in accordance with their respective quality of service, in queues (QC, QS, QI, QB) assigned to the respective quality of service,
the data (RBP1 to RSP2) are packed in data packets (RBP11, CP1, . . . , SP14), the data (RBP1 to RSP2) being at least partially segmented in each case as a function of at least one segmentation rule assigned to the relevant quality of service, and each data packet (RBP11, CP1, . . . , SP14) being assigned an item of data packet control information (PH, CHb, CHc) with the aid of which data (RBP1, RSP1), contained in individual data packets (CP1, CP2) or in data packets (RBP11 . . . RBP16; SP11 . . . SP14) of a data packet sequence, can be reconstructed,
as a function of at least one aggregation rule, containers (C1, C2) of a predetermined payload quantity are formed containing data packets (RBP11, CP1, . . . , SP14) and their respective associated data packet control information (PH, CHb, CHc), where, in at least a part of the containers (C1, C2), data packets (RBP11, CP1 . . . , SP14) containing data (RPB1 to RSP2) of different quality of service are combined per container and where the at least one aggregation rule specifies the priority rule in accordance with which data packets (RBP11, CP1, . . . , SP14) of different quality of service are extracted from the relevant queues (QC, QS, Q1, AB) and
a container (C1, C2) is in each case made available for transmission in a respective internet protocol datagram.

2. A method according to claim 1, characterised in that a user datagram protocol layer (UDPHD) is entered in the internet protocol datagrams on the internet protocol layer (IPHD).

3. A method according to claim 2, characterised in that the relevant container (C1, C2) is entered in an internet protocol datagram as payload of the user datagram protocol (UDPHD).

4. A method according to claim 1, characterised in that a container containing at least one data packet (RBP11, CP1, . . . , SP14) is transmitted when a predetermined time limit is reached, even if the relevant container (C1, C2) is not yet filled with data packets (RBP11, CP1, . . . , SP14) up to its predetermined payload quantity.

5. A method according to claim 1, characterised in that preferably data of low quality of service (RBP1 to RSP2) are segmented.

6. A method according to claim 1, characterised in that data (RBP1 to RSP2) relating to information transmitted or to be transmitted between transmission devices (NB1, NB2, NB3, RNC1, RNC2) of an access network, in particular a mobile telephony access network (ACCNET), in particular information transmitted or to be transmitted on transport channels (TR11, TR12, TR21, TR22) to mobile telephony terminals (UE1, UE2), are transmitted in the data packets (RBP11, CP1, . . . , SP14).

7. A method according to claims 2 and 6, characterised in that the internet protocol address used in an internet protocol datagram and the user datagram port indicated in the internet protocol datagram are used to identify a transport channel (TR11, TR12, TR21, TR22) of the mobile telephony access network (ACCNET) and/or to identify the type of the transport channel (TR11, TR12, TR21, TR22).

8. A method according to claim 6 or 7, characterised in that at least a portion of an identifier (CIDC, CIDS, CIDI, CIDB) for identifying a transport channel, and/or its transport channel type, of the mobile telephony access network (ACCNET) is entered in the item of control information (PH, CHb, CHc) in each case assigned to a data packet (RBP11, CP1, . . . SP14).

9. A method according to claim 1, characterised in that
the internet protocol datagrams are transmitted from a transmitting transmission device (NB3, TRNB) to a receiving transmission device (TRNC, RNC2) and
reconstruction means (RM) extract the data packets (RBP11, CP1, . . . , SP14) in each case contained in the containers of the internet protocol datagrams and forward the data (RBP1 to RSP2) contained therein, in accordance with their respective quality of service, to the destination provided for the relevant data (RBP1 to RSP2), where the reconstruction means (RM) forward data (RBP1 to RSP2) transmitted in a data packet sequence (RBP11 . . . RBP16; SP11 . . . SP14) only when they have reconstructed the data (RBP1 to RSP2) with the aid of the data packet control information (PH, CHb, CHc) in each case assigned to the relevant data packets (RBP11, CP1, . . . SP14).

10. A preparation module for a transmission device (NB3, RNC2), in particular for a transmission device (NB3, RNC2) of a mobile telephony access network (ACCNET), for the transmission of data (RBP1 to RSP2) of different quality of service in internet protocol datagrams, characterised in that:
the preparation module (SM) comprises classification means (CLASM) for arranging the data (RPB1 to RSP2), in accordance with their respective quality of service, in queues (QC, QS, QI, QB) assigned to the respective quality of service,
the preparation module (SM) comprises packing means (SEGSM) for packing the data (RPB1 to RSP2) in data packets (RBP11, CP1, . . . , SP14), where the packing means (SEGSM) segments the data (RBP1 to RSP2) at least partially in each case as a function of at least one segmentation rule assigned to the relevant quality of service and assigns each data packet (RBP11, CP1, . . . , SP14) an item of data packet control information (PH, CHb, CHc), with the aid of which data (RPB1, RSP1) contained in individual data packets (CP1, CP2) or in data packets (RBP11 . . . RBP16; SP11 . . . SP14) of a data packet sequence can be reconstructed,
the preparation module (SM) comprises aggregation means (AGSM) for forming containers of a predetermined payload quantity containing data packets (RBP11, CP1, . . . SP14) and their respective associated data packet control information (PH, CHb, CHc) as a function of at least one aggregation rule, where in at least a part of the containers (C1, C2) data packets (RBP11, CP1, . . . SP14) containing data (RBP1 to RSP2) of different quality of service are combined per container and where the at least one aggregation rule specifies the priority rule in accordance with which data packets (RBP11, CP1, . . . , SP14) of different quality of service are extracted from the relevant queues (QC, QS, QI, QB) and
the aggregation means (AGSM) are designed to make the containers (C1, C2) available for transmission by a transmitting device (TRNB, TRNC) of the transmission device (NB3, RNC2), a container (C1, C2) in each case being provided for transmission in a respective internet protocol datagram.

11. A preparation module (SM) according to claim 10, characterised in that it contains program code which can be executed by a control means (CPUTA, CPUTB) of the transmission device (NB3, RNC2).

12. A receiving module for a transmission device (NB3, RNC2), in particular for a transmission device (NB3, RNC2) of a mobile telephony access network (ACCNET), for transmitting data (RPB1 to RSP2) of different quality of service in internet protocol datagrams, characterised in that:
the receiving module (RM) comprises receiving means (RCVRM) for receiving containers, which are in each case transmitted in internet protocol datagrams to the receiving module (RM) and in which data packets (RBP11, CP, . . . , SP14) and items of data packet control information in each case assigned thereto are contained where, in at least a part of the containers (C1, C2), data packets (RPB11, CP1, . . . SP14) comprising data (RPB1 to RSP2) of different quality of service are contained in each container,
the receiving module (RM) comprises reconstruction means (ASSRM) for extracting the data packets (RPB11, CP1, . . . SP14) from the containers and for forwarding the data (RPB1 to RSP2) contained in the relevant containers to the destination in each case provided therefor and
the reconstruction means (ASSRM) are further designed such that the reconstruction means (ASSRM) do not forward data (RBP1, RSP1) transmitted in a data packet sequence (RBP11 . . . RBP16; SP11 . . . SP14) until the reconstruction means (ASSRM) have reconstructed the data (RBP1, RSP1) with the aid of the data packet control information (PH, CHb, CHc) in each case assigned to the relevant data packets (RBP11 . . . RBP16; SP11 . . . SP14).

13. A receiving module according to claim 12, characterised in that it contains program code which can be executed by a control means (CPUTA, CPUTB) of the transmission device (NB3, RNC2).

14. A transmission device (NB3, RNC2), in particular a transmission device (NB3, RNC2) for a mobile telephony access network, with a preparation module (SM) according to claim 10 or 11 and/or with a receiving module (RM) according to claim 12 or 13.

15. Storage means which can be read by a computer with a preparation module (SM) according to claim 11 stored thereon and/or with a receiving module (RM) according to claim 13 stored thereon.
